(19) United States
(12) Patent Application Publication
(10) Pub. No.: US 2026/0091703 A1
(43) Pub. Date: Apr. 2, 2026

(54) METHOD OF ENERGY MANAGEMENT BASED ON LOCATION

(71) Applicant: Volvo Car Corporation, Göteborg (SE)

(72) Inventors: Andreas ROPEL, Torslanda (SE); Jones SCHÖLD, Göteborg (SE); Fredrik HAAK, Ödsmål (SE); Ali FOTOUHI, Kungsbacka (SE); Virat ANDODARIYA, Göteborg (SE); Vijay ARUMUGAM, Göteborg (SE)

(73) Assignee: Volvo Car Corporation, Göteborg (SE)

(21) Appl. No.: 18/899,547

(22) Filed: Sep. 27, 2024

(51) Int. Cl. B60L 53/68; B60L 53/66; B60L 55/00; G01C 21/34

(52) U.S. Cl. CPC B60L 53/68; B60L 53/665; B60L 55/00; G01C 21/3469; G01C 21/3476; B60L 2240/622; B60L 2240/72

(57) ABSTRACT

A system is described. The system comprises: a global positioning unit; a battery management system; and a processor storing instructions in non-transitory memory. The processor is operable to: detect, via the global positioning unit, that a vehicle moved from a first geographical range to a second geographical range during a first scheduled session corresponding to a first grid; identify a second grid upon the vehicle entering the second geographical range; establish a connection between the vehicle and the second grid located within the second geographical range; and communicate a command to the battery management system to perform one of charging and discharging at the second grid, using an artificial intelligence engine trained based on first charging information and first discharging information obtained from all first grids and second grids over time.

### FIELD OF THE INVENTION

The present disclosure relates generally to charging systems for electric vehicles. More specifically, the present disclosure relates to a system and method of energy management based on a location of the electric vehicles.

### BACKGROUND

Nowadays, electric vehicles are equipped with an energy management system that adjusts how they charge, and discharge energy based on interactions with local power grids. Using Artificial Intelligence (AI) technology, this system learns over time to optimize efficiency and cost-effectiveness when charging and using energy at home or work, for example. However, when the electric vehicles travel away from these familiar locations, such as visiting friends or family, the system loses its learned patterns. This disruption means it takes more time for the system to readjust to new charging environments.

Therefore, there is a long-felt need for a system and method of energy management based on the location of the electric vehicles.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate energy management based on the location of the electric vehicles.

In an aspect, a system is described. The system comprises: a global positioning unit; a battery management system; and a processor storing instructions in non-transitory memory. The processor is operable to detect, via the global positioning unit, that a vehicle moved from a first geographical range to a second geographical range during a first scheduled session corresponding to a first grid; identify a second grid upon the vehicle entering the second geographical range; establish a connection between the vehicle and the second grid located within the second geographical range; and communicate a command to the battery management system to perform one of charging and discharging at the second grid, using an artificial intelligence engine trained based on first charging information and first discharging information obtained from the first grid over time.

In one aspect, a method is described. The method comprises: detecting, via a global positioning unit, that a vehicle moved from a first geographical range to a second geographical range during a first scheduled session corresponding to a first grid; identifying a second grid upon the vehicle entering the second geographical range; establishing a connection between the vehicle and the second grid located within the second geographical range; and communicating a command to a battery management system to perform one of charging and discharging at the second grid, using an artificial intelligence engine trained based on first charging information and first discharging information obtained from the first grid over time.

In one aspect, a non-transitory computer readable storage medium is described. The non-transitory computer readable storage medium comprising a sequence of instructions, which when executed by a processor causes: detecting, via a global positioning unit, that a vehicle moved from a first geographical range to a second geographical range during a first scheduled session corresponding to a first grid; identifying a second grid upon the vehicle entering the second geographical range; establishing a connection between the vehicle and the second grid located within the second geographical range; and communicating a command to a battery management system to perform one of charging and discharging at the second grid, using an artificial intelligence engine trained based on first charging information and first discharging information obtained from the first grid over time.

In one aspect, a vehicle is described. The vehicle comprising; a global positioning unit; a battery management system; and a processor storing instructions in non-transitory memory that, when executed, causes the processor to: detect, via the global positioning unit, that the vehicle moved from a first geographical range to a second geographical range during a first scheduled session corresponding to a first grid; identify a second grid upon the vehicle entering the second geographical range; establish a connection between the vehicle and the second grid located within the second geographical range; and communicate a command to the battery management system to perform one of charging and discharging at the second grid, using an artificial intelligence engine trained based on first charging information and first discharging information obtained from the first grid over time.

In one aspect, a vehicle is described. The vehicle comprising: a processor storing instructions in non-transitory memory that, when executed, causes the processor to: identify a second grid when a vehicle enters a second geographical area associated with the second grid; establish a connection with a second energy management system of the second grid; and transmit data collected over time with a first energy management system of a first grid to the second energy management system upon establishing the connection with the second energy management system.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system, according to one or more embodiments.

FIG. 2 illustrates a method, according to one or more embodiments.

FIG. 3 illustrates a non-transitory computer readable storage medium block diagram, according to one or more embodiments.

FIG. 4 illustrates a battery pack comprising an individual battery, according to one or more embodiments.

FIG. 5 illustrates a battery pack comprising a plurality of batteries, according to one or more embodiments.

FIG. 6 schematically shows a battery pack comprising a battery and a battery management system, according to one or more embodiments.

FIG. 7 illustrates first charging information received from a first grid, according to one or more embodiments.

FIG. 8 illustrates first discharging information received from a first grid, according to one or more embodiments.

FIG. 9 illustrates second charging information received from a second grid, according to one or more embodiments.

FIG. 10 illustrates second discharging information received from a second grid, according to one or more embodiments.

FIG. 11 illustrates a vehicle within a first geographical range, according to one or more embodiments.

FIG. 12A illustrates a vehicle moving from a first geographical range to a second geographical range, according to one or more embodiments.

FIG. 12B illustrates establishment of a connection between the vehicle and the second grid, according to one or more embodiments.

FIG. 13 illustrates a communication flow between a system, a first grid, and a second grid, according to one or more embodiments.

FIG. 14 shows an example block diagram for an artificial intelligence (AI) engine used in generating at least one command to perform one of charging and discharging according to one or more embodiments.

FIG. 15A shows a structure of the neural network/machine learning model with a feedback loop.

FIG. 15B shows a structure of the neural network/machine learning model with reinforcement learning.

FIG. 16A shows a block diagram of the cyber security module in view of the system and server.

FIG. 16B shows an embodiment of the cyber security module.

FIG. 16C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B”is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Controller (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “electric vehicle (EV)” refers to an automobile, as defined in 49 Code of Federal Regulations (CFR) 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or-more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg, (10,000 lbs.) gross vehicle weight.

As used herein, the term “Global Positioning Unit (GPS)” refers to a satellite-based navigation system that utilizes signals from satellites to accurately determine the geographic location, velocity, and time of a GPS receiver. This technology is fundamental for precise positioning and navigation across various sectors such as vehicle navigation, precision agriculture, and emergency response. In the realm of electric vehicles (EVs), GPS serves functions essential for efficient operation and management. The Global Positioning Unit (GPS) enables real-time tracking of EV locations, facilitating effective fleet management and logistics planning. GPS also plays a crucial role in optimizing driving routes and strategically planning charging stops to maximize energy efficiency.

As used herein, the term “Battery Management System (BMS)” refers to an integrated electronic system designed to monitor and regulate operational parameters of a battery pack. The BMS ensures optimal performance, longevity, and safety by monitoring individual cell voltages, temperatures, and currents within the battery pack. The term “Battery Management System (BMS)” accurately estimates the State of Charge (SoC) and State of Health (SoH) of the battery, providing data for efficient charging strategies and predicting battery life. The BMS includes safety features to protect against overcharging, overheating, and other potential hazards, thereby enhancing the reliability and durability of electric vehicle batteries.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It may be expressed in percentage form. The battery pack may comprise one or more batteries.

As used herein, the term “grid” refers to an energy grid system, which is an interconnected network for delivering electricity from producers to consumers. The grid comprises power generation facilities, transmission lines, distribution networks, and energy management systems.

As used herein, the term “first grid” refers to the energy grid system in the first geographical area where the vehicle is connected, collecting data on the vehicle's energy usage and contribution.

As used herein, the term “second grid” refers to the energy grid system in the second geographical area where the vehicle enters, with which the vehicle establishes a new communication link to continue managing its energy transfer.

As used herein, the term “first geographical range” refers to the extent or distance through which the vehicle or other entity communicates with a first grid.

As used herein, the term “second geographical range” refers to the extent or distance through which the vehicle or other entity communicates with a second grid.

As used herein, the term “first scheduled session” refers to a predefined time slot or session start time when an electric vehicle charges its battery from the first grid and when it discharges electricity back into the first grid.

As used herein, the term “second scheduled session” refers to a predefined time slot or session start time when an electric vehicle charges its battery from the second grid and when it discharges electricity back into the second grid.

As used herein, the term “first charging station” refers to a device that includes at least one docking terminal with a charger for charging a battery pack. The battery pack may comprise one or more batteries. The term “first charging station” refers to an apparatus that can function as a source of power for charging the battery pack of an electric vehicle including facilitating data communications between the electric vehicle and the first charging station. Communications may be established through a wired connection or a wireless connection. The first charging station is also capable of charging the electric vehicle either through a wired connection or a wireless connection.

As used herein, the term “second charging station” refers to a device that includes at least one docking terminal with a charger for charging a battery pack. The battery pack may comprise one or more batteries. The term “second charging station” refers to an apparatus that can function as a source of power for charging the battery pack of an electric vehicle including facilitating data communications between the electric vehicle and the second charging station. These communications may be established through a wired connection or a wireless connection. The second charging station is also capable of charging the electric vehicle either through a wired connection or a wireless connection.

As used herein, the term “command” refers to instructions given to perform a specific function. The command may specify a particular operation such as performing arithmetic calculations, moving data between memory locations, branching to a different part of the program, or interacting with input/output devices. Commands, via communication messages, are encoded in binary format and are represented by a sequence of bits that the appropriate module interprets and executes. The module fetches instructions and decodes them to determine the operation to perform, and then executes them accordingly.

As used herein, the term “charging” refers to an event starting when a user or a vehicle initiates a refueling event (e.g., charging) and stops when a user or a vehicle ends a refueling event (e.g., charging). The charging further refers to a charging occurrence for a single EV, during which a certain amount of energy is transmitted to the EV, measured in duration according to the time of the EV's plug-in (wireless or wired) to the EVSE to the time of the EV's physical plug-out from the EVSE.

As used herein, the term “discharging” refers to the process where an EV's battery releases stored energy for various applications. In one embodiment, the vehicle may release stored energy via technology such as Vehicle-to-Everything (V2X), which includes Vehicle-to-Grid (V2G), Vehicle-to-Home (V2H), and Vehicle-to-Load (V2L), etc.

As used herein, the term “first notification” refers to a communication sent by a processor or system to the first grid when it detects an electric vehicle (EV) moving from the first geographical range to the second during a scheduled session. The first notification is transmitted using data transmission protocols over internet or intranet networks, Application Programming Interface (API) for direct software integration, or through messaging services such as Short Message Service (SMS) or email.

As used herein, the term “identification information” within the first notification refers to specific data that uniquely identifies both the first scheduled session and the second geographical range related to an electric vehicle's activity. The identification information may include details about the scheduled session, such as the start time, end time, duration, and any relevant parameters governing the charging or operational activities of the EV during that session.

As used herein, the term “charging start time” refers to the specific moment when an electric vehicle (EV) begins to receive electrical power from a charging station or external power source. The charging start time is initiated by actions such as connecting a charging plug to the vehicle, activating a scheduled charging session, or through automated systems.

As used herein, the term “charging end time” refers to the specific moment when an electric vehicle (EV) completes the process of receiving electrical power from a charging station or external power source. The term “charging end time” refers to the conclusion of the charging session, indicating that the EV's battery has reached its desired level of charge or that charging has been terminated.

As used herein, the term “discharging start time” refers to the specific moment when an electric vehicle (EV) begins to supply electrical power from its battery to external sources, such as through vehicle-to-grid (V2G) systems or other discharge mechanisms. The term “discharging start time”refers to the initiation of the EV's contribution of stored electricity to, e.g., the grid.

As used herein, the term “discharging end time” refers to the specific moment when an electric vehicle (EV) completes the process of supplying electrical power from its battery to external sources, such as through vehicle-to-grid (V2G) systems or other discharge mechanisms. The term “discharging end time” refers to the conclusion of the discharging session, indicating that the EV has finished transferring its stored electricity to the grid or other designated electrical storage sources.

As used herein, the term “interactive menu” refers to a digital interface component designed to facilitate user navigation and interaction with content on websites, applications, or other digital platforms. The interactive menu is characterized by its ability to respond to user inputs, providing a dynamic and engaging experience.

As used herein, the term “optimized route” refers to a route to the intended destination covering the shortest distance through which the vehicle can travel with less traffic condition and in less time. The optimized route refers to a route through which the vehicle travels with fuel, battery charge, and with efficiency.

As used herein, the term “monetization opportunity” within the electric vehicle (EV) industry refers to potential avenues for generating revenue or creating value specific to this sector. The term “Monetization opportunity” includes strategies such as providing Vehicle-to-Grid (V2G) services, where EVs can supply electricity during peak demand or assist in stabilizing the grid, thereby facilitating revenue generation.

As used herein, the terms “user interactions” refer to various actions, commands, inputs, or selections made by a user through an interactive interface or menu system. The term “user interactions” includes selecting options, entering data, activating commands, adjusting settings, or any other form of engagement that initiates or modifies operations within a system or application. The processor responds to these interactions by executing corresponding functions, processes, or actions, such as establishing connections between a vehicle and a grid based on the user's menu selections.

As used herein, the term “first charging information” refers to a set of data elements related to the initial charging process of an electric vehicle (EV) at a specific charging station associated with the first grid. This set of data elements includes the unique identification number of the first charging station, the scheduled session time for charging, and the chosen mode of charging, whether it's standard Alternating Current (AC), Direct Current (DC) fast charging, or wireless. Further, the term “first charging information” refers to the geographical location of the first charging station, the amount of electrical energy transferred to the vehicle, the rate at which this energy is delivered, and the duration of the charging session.

As used herein, the term “second charging information” refers to a set of data elements related to the charging process of an electric vehicle (EV) at a specific charging station associated with the second grid. This set of data elements includes the unique identification number of the second charging station, the scheduled session time for charging, and the chosen mode of charging, whether it's standard AC, DC fast charging, or wireless. Further, the term “second charging information” refers to the geographical location of the second charging station, the amount of electrical energy transferred to the vehicle, the rate at which this energy is delivered, and the duration of the charging session.

As used herein, the term “first mode of charging” refers to a method or protocol used to transfer electrical energy from the first grid to recharge the battery of an electric vehicle (EV). The mode of charging includes one of wired charging and wireless charging. The selection of the first mode of charging depends on factors such as EV compatibility, charging infrastructure availability, desired charging speed, and user preferences.

As used herein, the term “second mode of charging” refers to a method or protocol used to transfer electrical energy from the second grid to recharge the battery of an electric vehicle (EV). The mode of charging includes one of wired charging and wireless charging. The selection of the first mode of charging depends on factors such as EV compatibility, charging infrastructure availability, desired charging speed, and user preferences.

As used herein, the term “first charging cost” refers to an initial expenditure involved in recharging an electric vehicle (EV) battery from the first grid during its first charging session. This includes the expenses associated with the initial instance of charging the EV, including factors such as the cost per kilowatt-hour (kWh) of electricity, the duration of the charging session, any supplementary fees linked to the charging infrastructure, and other variables that may impact the overall charging expense.

As used herein, the term “second charging cost” refers to an initial expenditure involved in recharging an electric vehicle (EV) battery from the second grid during its second charging session. This includes the expenses associated with the initial instance of charging the EV, including factors such as the cost per kilowatt-hour (kWh) of electricity, the duration of the charging session, any supplementary fees linked to the charging infrastructure, and other variables that may impact the overall charging expense.

As used herein, the term “first charging duration” refers to the total elapsed time taken for an electric vehicle (EV) to complete its initial charging session from the beginning of connecting to the first charging station until the EV is fully charged or reaches a desired state of charge. This duration is measured in hours and minutes and is influenced by factors such as the charging rate, battery capacity, and initial charge level. The user may provide the charging duration. The charging duration may also be determined by the first charging station or the charging system. The charging duration may be split into charging time segments. Each charging time segment may correspond to a different charging level. Each charging time segment may correspond to charging a different portion of the battery pack.

As used herein, the term “second charging duration” refers to the total elapsed time taken for an electric vehicle (EV) to complete its initial charging session from the beginning of connecting to the second charging station until the EV is fully charged or reaches a desired state of charge. This duration is measured in hours and minutes and is influenced by factors such as the charging rate, battery capacity, and initial charge level. The user may provide the charging duration. The charging duration may also be determined by the second charging station or the charging system. The charging duration may be split into charging time segments. Each charging time segment may correspond to a different charging level. Each charging time segment may correspond to charging a different portion of the battery pack.

As used herein, the term “first charging sequence” refers to a charging pattern defined by the charging system or the first charging station based on the vehicle's battery parameters (e.g., state-of-charge, state-of-health) and charging time. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

As used herein, the term “second charging sequence” refers to a charging pattern defined by the charging system or the second charging station based on the vehicle's battery parameters (e.g., state-of-charge, state-of-health) and charging time. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

As used herein, the term “first charging temperature” refers to the ambient or battery temperature conditions observed or controlled during the initial charging session of an EV with the first charging station.

As used herein, the term “second charging temperature” refers to the ambient or battery temperature conditions observed or controlled during the charging session of an EV with the second charging station.

As used herein, the term “first discharging information” refers to a set of data and details concerning the initial process of discharging electrical energy from an electric vehicle (EV) back to the first charging station or grid. The first discharging information includes at least one of a first mode of discharging, an amount of energy discharged from the vehicle to the first charging station, a first monetary value, a first discharging duration, a first discharging sequence, and a first discharging temperature.

As used herein, the term “second discharging information” refers to a set of data and details concerning the initial process of discharging electrical energy from an electric vehicle (EV) back to the second charging station or grid. The second discharging information includes at least one of a second mode of discharging, an amount of energy discharged from the vehicle to the second charging station, a second monetary value, a second discharging duration, a second discharging sequence, and a second discharging temperature.

As used herein, the term “first mode of discharging” refers to a method or protocol used when an electric vehicle (EV) transfers electrical energy from its battery back to the first charging station or grid. The first mode of discharging includes various strategies such as vehicle-to-grid (V2G) systems, where EVs discharge electricity to support grid stability or meet demand response needs.

As used herein, the term “second mode of discharging” refers to a method or protocol used when an electric vehicle (EV) transfers electrical energy from its battery back to the second charging station or grid. The second mode of discharging includes various strategies such as vehicle-to-grid (V2G) systems, where EVs discharge electricity to support grid stability or meet demand response needs.

As used herein, the term “first monetary value” refers to the financial cost or value associated with the electricity discharged from the EV to the first charging station or grid. This value is calculated based on factors such as the electricity rate per kWh, any applicable tariffs, and the amount of energy discharged.

As used herein, the term “second monetary value” refers to the financial cost or value associated with the electricity discharged from the EV to the second charging station or grid. This value is calculated based on factors such as the electricity rate per kWh, any applicable tariffs, and the amount of energy discharged.

As used herein, the term “first discharging duration” refers to the length of time taken for the EV to complete its discharging session at the first charging station, from the initiation of energy transfer to completion or interruption. This duration is measured in hours and minutes and depends on factors such as discharging rate, battery capacity, and discharging efficiency.

As used herein, the term “second discharging duration” refers to the length of time taken for the EV to complete its discharging session at the second charging station, from the initiation of energy transfer to completion or interruption. This duration is measured in hours and minutes and depends on factors such as discharging rate, battery capacity, and discharging efficiency.

As used herein, the term “first discharging sequence” refers to the chronological order or sequence of events occurring during the discharging process of an EV at the first charging station. The first discharging sequence includes steps such as initiating the discharging session, monitoring energy transfer progress, and any adjustments or interruptions that may occur.

As used herein, the term “second discharging sequence” refers to the chronological order or sequence of events occurring during the discharging process of an EV at the second charging station. The second discharging sequence includes steps such as initiating the discharging session, monitoring energy transfer progress, and any adjustments or interruptions that may occur.

As used herein, the term “first discharging temperature” refers to the ambient or battery temperature conditions observed or managed during the discharging session of an EV at the first charging station.

As used herein, the term “second discharging temperature” refers to the ambient or battery temperature conditions observed or managed during the discharging session of an EV at the second charging station.

As used herein, the term “battery pack” as used herein refers to a set of any number of identical batteries or individual cells of a battery. The “battery pack” may also refer to a set of non-identical batteries. The batteries in the battery pack may be configured in a series, parallel or a mixture of both to deliver the desired voltage, capacity, and/or power density.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “communication protocols” refer to a set of rules and standards that govern the exchange of data between devices or systems. The communication protocols define the format, sequence, error checking, and authentication mechanisms required for reliable communication. Examples include TCP/IP (Transmission Control Protocol/Internet Protocol) for internet communication, Bluetooth for wireless data transfer between devices, and CAN (Controller Area Network) for communication between electronic control units in vehicles.

As used herein, the term “state-of-charge (SoC)” refers to the level of charge of an electric battery pack relative to its capacity. The units of SoC are percentage points (0%=empty; 100%=full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

As used herein, the term “bidirectional communication” refers to an exchange of data between two components. In an example, the first component can be a vehicle and the second component can be an infrastructure that is enabled by a system of hardware, software, and firmware. This communication is typically wireless. In another example, the first component can be a charging system and the second component can be a charging station.

As used herein the term “amount of charging needed” refers to a charge that is required to reach the destination (i.e. charge required to travel from current location of vehicle to the charging station) and the charge to be released. The amount of charging needed may also include the charge required to complete an upcoming action in the schedule/itinerary.

As used herein the term “distribution or acceptance parameters” refer to the variables and criteria used by an energy grid (e.g., the first grid or the second grid) to manage the distribution of electricity and the acceptance of energy inputs. These parameters comprise load distribution, capacity limits, supply-demand balance, energy storage management, quality of service, renewable energy integration, grid stability, and cost optimization.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

The term “vehicle” as used herein refers to a thing used for transporting people or goods. Automobiles, cars, trucks, buses, etc., are examples of vehicles.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “artificial intelligence (AI)” refers to a mathematical or computational construct designed to perform tasks that typically require human intelligence, such as recognizing patterns, making decisions, predicting outcomes, and understanding natural language. These models are trained on data using algorithms that allow them to learn from this data, enabling them to make inferences or predictions based on new inputs. The training process comprises adjusting the model's parameters to minimize errors and enhance performance on specific tasks. The AI models can be categorized into several types, including supervised learning models, which learn from labelled data; unsupervised learning models, which identify patterns and structures in unlabelled data; semi-supervised learning models, which utilize a combination of labelled and unlabelled data; reinforcement learning models, which learn optimal actions through trial and error; and deep learning models, which are neural networks with multiple layers designed to learn hierarchical representations of data. Additionally, natural language processing models specialize in understanding and generating human language, while hybrid models combine different types of AI models to leverage their respective strengths and compensate for their weaknesses. Each type of AI model is tailored to specific problems and data, and the selection of an appropriate model depends on the task, the nature of the data, and the desired outcomes.

As used herein, the term “vehicle state information” refers to data and parameters that describe the current operational status, condition, and performance of the vehicle. This includes details such as battery state of charge (SoC), battery voltage and temperature, powertrain status, charging status, energy consumption metrics, vehicle speed and acceleration, regenerative braking data, and fault codes.

As used herein, the term “first billing information” refers to how electricity consumption is measured and billed when charging an EV from the first grid. The first billing information of the first grid includes details such as charging rates (cost per kWh), session start and end times, total kWh consumed, tariff options (e.g., flat rates, time-of-use), and metering methods (e.g., smart meters).

As used herein, the term “second billing information” refers to how electricity is measured, billed, and managed when an electric vehicle (EV) is used to supply power back to the second grid. The second billing information of the first grid includes details such as charging rates (cost per kWh), session start and end times, total kWh consumed, tariff options (e.g., flat rates, time-of-use), and metering methods (e.g., smart meters).

As used herein, the term “tariff rates” refer to the specific pricing structures or rates applied to the consumption or supply of electricity by the first grid and the second grid. These rates vary depending on factors such as time of day, day of the week, season, and the amount of electricity used or supplied.

As used herein, the term “first payment details” refers to the initial set of information regarding financial transactions related to supplying energy from a vehicle to the first grid. The first payment details comprise specifics such as the amount paid for the energy supplied, details of the payment method used, identification of the payer and payee, and any relevant transaction identifiers or reference.

As used herein, the term “second payment details” refers to the initial set of information regarding financial transactions related to supplying energy from a vehicle to the second grid. The second payment details comprise specifics such as the amount paid for the energy supplied, details of the payment method used, identification of the payer and payee, and any relevant transaction identifiers or reference.

As used herein, the term “first cost breakdown” refers to an initial breakdown of expenses or costs associated with supplying energy from a vehicle to the first grid. The first cost breakdown categorizes and itemizes the various components that contributed to the total cost, providing a clear understanding of how resources and expenditures are allocated in the process of energy transfer.

As used herein, the term “second cost breakdown” refers to an initial breakdown of expenses or costs associated with supplying energy from a vehicle to the second grid. The second cost breakdown categorizes and itemizes the various components that contributed to the total cost, providing a clear understanding of how resources and expenditures are allocated in the process of energy transfer.

As used herein, the term “first transaction timestamps” refers to the exact times when key actions or transactions occurred during the process of supplying energy from a vehicle to the first grid.

As used herein, the term “second transaction timestamps” refers to the exact times when key actions or transactions occurred during the process of supplying energy from a vehicle to the second grid.

As used herein, the term “first energy source information” refers to the specific details or data that identify the primary sources of energy utilized by the vehicle when supplying energy from the first grid. These sources comprise renewable sources, such as solar, wind, hydroelectric, or biomass, which generate electricity using natural and sustainable resources. Additionally, conventional sources, such as fossil fuels (coal, natural gas, oil) or nuclear power, may also be part of these sources.

As used herein, the term “second energy source information” refers to the specific details or data that identify the primary sources of energy utilized by the vehicle when supplying energy from the second grid. These sources comprise renewable sources, such as solar, wind, hydroelectric, or biomass, which generate electricity using natural and sustainable resources. Additionally, conventional sources, such as fossil fuels (coal, natural gas, oil) or nuclear power, may also be part of these sources.

As used herein, the term “first load and demand data” refers to information concerning the energy load and demand characteristics of the first grid. The first load and demand data comprise real-time data on current energy consumption levels, historical records of past load patterns, and predictive insights into future energy demands.

As used herein, the term “second load and demand data” refers to information concerning the energy load and demand characteristics of the second grid. The second load and demand data comprise real-time data on current energy consumption levels, historical records of past load patterns, and predictive insights into future energy demands.

As used herein, the term “vehicle routing and navigation data” refers to detailed information regarding the routes and navigation of a vehicle. The vehicle routing and navigation data comprise real-time GPS data for precise location tracking, historical data on previous routes travelled, and planned routes along with scheduled stops for future journeys.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem: As electric vehicles (EVs) become more advanced with integrated energy management systems that optimize charging and discharging based on historical data and grid interactions, these systems face significant challenges when vehicles travel outside their known geographical areas. This disrupts the energy management process, leading to inefficiencies in energy usage, increased recalibration time, and reduced monetization opportunities.

Business solution: The present system establishes communication with a new grid when an electric vehicle (EV) enters a different geographical area. The system can transfer data from previous grid interactions, including historical data and energy availability preferences to the new grid. The system notifies the original grid of any changes in availability, such as adjustments to discharging schedules. Upon receiving this information, the new grid optimizes its energy management parameters to integrate the EV efficiently into its distribution strategy. This present system ensures energy management, maximizes operational benefits across various locations, and enhances the flexibility and effectiveness of EVs in supporting grid operations.

Technical problem: Current energy management systems in EVs are efficient within their known geographical areas but become significantly less efficient when the vehicles travel to new locations. The systems cannot utilize learned data for optimizing charging and discharging processes in unfamiliar grids, leading to inefficiencies and increased recalibration time. Additionally, the absence of a standardized communication protocol between different grids makes it difficult for EVs to maintain optimal energy management.

Technical Solution: The present system enables EVs to interact with different grids as they move between geographical areas. The present system identifies and connects with new grids when EVs enter new locations. The system shares historical data and the learned optimization strategies with the new grid's energy management system. The system also enables the EVs to communicate their current energy status, available charge, and discharging information to the new grid, including details such as billing information and energy source information. Additionally, the original grid is notified when the EV moves to a new location, allowing it to adjust its energy management plans accordingly. By implementing these technical solutions, EVs will maintain efficient energy management and monetization opportunities, regardless of their location.

Technical Result: The system can connect and interact with different grids, ensuring continuous optimization of charging and discharging processes regardless of geographical location. The artificial intelligence engine adjusts to new grid parameters, reducing the time needed for recalibration and maintaining efficient energy management. The system utilizes historical data and learns optimization practices in new locations, leading to energy efficiency and reduced wastage. By communicating energy availability and optimal discharging times, the vehicle can maximize monetization opportunities even when traveling outside their usual areas. Additionally, grids can dynamically adjust their energy management plans based on real-time data from EVs, resulting in overall grid stability and efficiency.

### Technical Details Specific to Technical Result

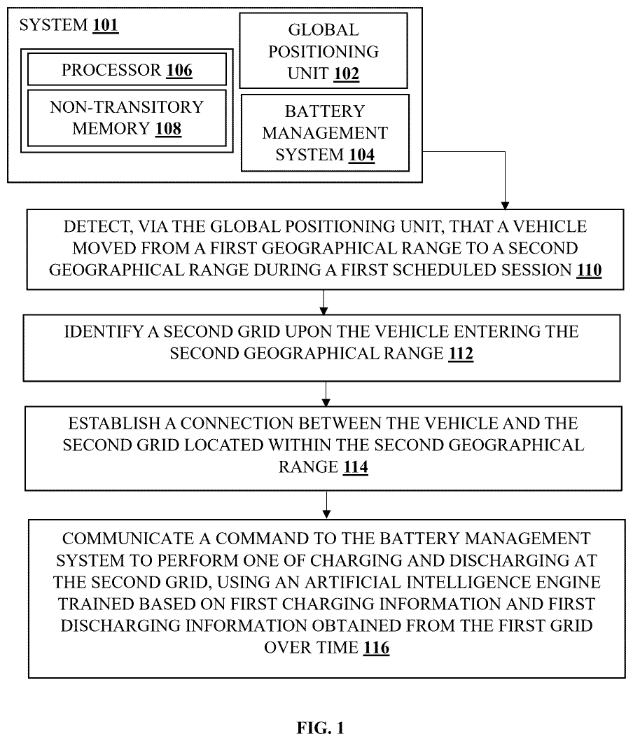

In an aspect, a system is described. As an example, FIG. 1 illustrates a system, according to one or more embodiments. The system 101 comprises: a global positioning unit 102; a battery management system 104; and a processor 106 storing instructions in non-transitory memory 108. The processor 106 is operable to detect, via the global positioning unit 102, that a vehicle moved from a first geographical range to a second geographical range during a first scheduled session corresponding to a first grid (at step 110); identify a second grid upon the vehicle entering the second geographical range (at step 112); establish a connection between the vehicle and the second grid located within the second geographical range (at step 114); and communicate a command to the battery management system 104 to perform one of charging and discharging at the second grid, using an artificial intelligence engine trained, based on first charging information and first discharging information obtained from the first grid over time (at step 116).

In one embodiment, the processor 106 is operable to transmit a first notification to the first grid upon detecting movement of the vehicle from the first geographical range to the second geographical range during the first scheduled session. In one embodiment, the first notification comprises identification information of the second geographical range and the first scheduled session.

In one embodiment, the first scheduled session comprises a charging start time and a charging end time of the first grid. In one embodiment, the first scheduled session comprises a discharging start time and a discharging end time of the first grid.

In one embodiment, the processor 106 is operable to determine, using the global positioning unit 102, a distance between a current location of the vehicle and a location of a second charging station associated with the second grid upon the vehicle entering the second geographical range. In one embodiment, the processor 106 is operable to display an interactive menu onto a display of the vehicle depicting a monetization opportunity and an optimized route to the location of the second charging station upon determining the distance between the current location of the vehicle and the location of the second charging station. In one embodiment, the second charging station is a Vehicle-to-Everything (V2X), that comprises Vehicle-to-Grid (V2G), Vehicle-to-Home (V2H), and Vehicle-to-Load (V2L).

In one embodiment, the processor 106 is operable to establish the connection between the vehicle and the second grid based on user interactions with the user interactive menu.

In one embodiment, the processor 106 is operable to transmit the first charging information and the first discharging information to the second grid upon establishing the connection between the vehicle and the second grid.

In one embodiment, the first charging information comprises an identification number of a first charging station associated with the first grid, the first scheduled session, a first mode of charging, a location of the first charging station, an amount of energy transferred from the first charging station to the vehicle, a first charging cost, a first charging duration, a first charging sequence, and a first charging temperature. In one embodiment, the first discharging information comprises at least one of a first mode of discharging, an amount of energy discharged from the vehicle to the first charging station, a first monetary value, a first discharging duration, a first discharging sequence, and a first discharging temperature.

In one embodiment, the first charging station is a Vehicle-to-Everything (V2X), that comprises Vehicle-to-Grid (V2G), Vehicle-to-Home (V2H), and Vehicle-to-Load (V2L).

In one embodiment, the processor 106 is operable to communicate a second notification to the first grid upon establishing the connection between the vehicle and the second grid during the first scheduled session. In an embodiment, the system enables the first grid to recalibrate the first scheduled session based on the second notification.

In one embodiment, the processor 106 is operable to automatically identify communication protocols and network parameters of the second grid upon detecting entry of the vehicle into the second geographical range. In one embodiment, the processor 106 is operable to initiate a communication link between the vehicle and the second grid upon identifying the communication protocols and the network parameters.

In one embodiment, the processor 106 is operable to transmit vehicle state information to the second grid. In one embodiment, the processor 106 is operable to transmit the vehicle state information to the first grid. In one embodiment, the vehicle state information comprises at least one of location information of the vehicle, information of a travel path set in a navigation system, state-of-charge (SoC) of a battery pack, and information of battery power consumed per unit time.

In one embodiment, the processor 106 is operable to transmit first billing information to the second grid. In one embodiment, the first billing information comprises an amount of energy discharged from the vehicle to the first grid, tariff rates applied by the first grid for energy discharge, first payment details, first cost breakdown, and first transaction timestamps corresponding to the first grid.

In one embodiment, the processor 106 is operable to transmit first energy source information to the second grid. In one embodiment, the first energy source information comprises identification of primary energy sources utilized by the vehicle at the first grid. In one embodiment, the primary energy sources comprise one or more of one or more renewable sources and one or more conventional sources.

In one embodiment, the processor 106 is operable to train the Artificial intelligence engine based on the vehicle state information, the first billing information, the first energy source information, the user preference, first load and demand data of the first grid, and vehicle routing and navigation data. In one embodiment, the first load and demand data comprise real-time data on current load conditions of the first grid, historical data on one or more load levels of the first grid, and predictions about future demands of the first grid. In one embodiment, the vehicle routing and navigation data comprise real-time GPS data obtained from the global positioning unit, historical data on previous routes travelled by the vehicle and driving behaviours, and planned routes and intermediary stops for future journeys. In one embodiment, the second grid recalibrates its distribution or acceptance parameters upon receiving the vehicle state information, the first billing information, the first energy source information, the user preference, the first load and demand data of the first grid, and the vehicle routing and navigation data.

In one embodiment, the processor 106 is operable to receive second charging information and second discharging information from the second grid. In one embodiment, the second charging information comprises an identification number of the second charging station, a second scheduled session, a second mode of charging, the location of the second charging station, an amount of energy transferred from the second charging station to the vehicle, a second charging cost, a second charging duration, a second charging sequence, and a second charging temperature. In one embodiment, the second discharging information comprises at least one of a second mode of discharging, an amount of energy discharged from the vehicle to the second charging station, a second monetary value, a second discharging duration, a second discharging sequence, and a second discharging temperature.

In one embodiment, the processor 106 is operable to receive second billing information from the second grid. In one embodiment, the second billing information comprises an amount of energy discharged from the vehicle to the second grid, tariff rates applied by the second grid for energy discharge, second payment details, second cost breakdown, and second transaction timestamps corresponding to the second grid.

In one embodiment, the processor 106 is operable to receive second energy source information from the second grid. In one embodiment, the processor 106 is operable to transmit the second charging information, the second discharging information, the second billing information and the second energy source information to the first grid.

In one embodiment, the processor 106 is operable to establish a connection with the first grid and the second grid simultaneously. In one embodiment, the connection with the first grid and the second grid is established through a network. In one embodiment, the network comprises a communication network selected from a group comprising wired networks, wireless networks, and a combination thereof.

In one embodiment, the system 101 is integrated into the vehicle.

In one embodiment, the processor 106 is operable to establish the connection with the first grid and the second grid through a vehicle computer system. In one embodiment, the processor 106 is operable to train the Artificial intelligence engine based on the second charging information, the second discharging information, the second billing information, the second energy source information, and second load and demand data of the second grid.

How Technical Solution is a Technological Advancement: The technical solution enables adaptive energy management and grid integration across different geographical areas. The technical solution optimizes charging and discharging strategies based on learned patterns, thereby enhancing energy efficiency and promoting grid stability. This capability supports efficient resource management and improves grid reliability. Additionally, the technical solution enhances user convenience by automatically adjusting energy management strategies according to location, ensuring optimal energy monetization and reducing the need for manual recalibration.

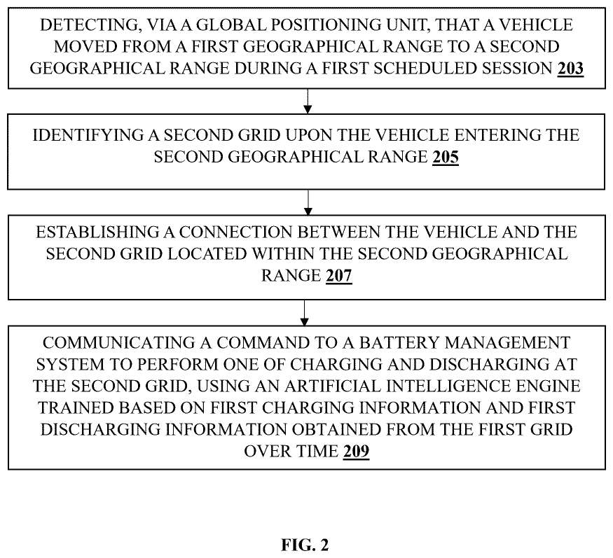

In one aspect, a method is described. As an example, FIG. 2 illustrates a method according to one or more embodiments. The method comprises the following technical steps: detecting, via a global positioning unit, that a vehicle moved from a first geographical range to a second geographical range during a first scheduled session corresponding to a first grid (at step 203); identifying a second grid upon the vehicle entering the second geographical range (at step 205); establishing a connection between the vehicle and the second grid located within the second geographical range (at step 207); and communicating a command to a battery management system to perform one of charging and discharging at the second grid, using an artificial intelligence engine trained, based on first charging information and first discharging information obtained from the first grid over time (at step 209).

In one embodiment, the method further comprises: transmitting a first notification to the first grid upon detecting movement of the vehicle from the first geographical range to the second geographical range during the first scheduled session.

In one embodiment, the first notification comprises identification information of the second geographical range and the first scheduled session.

In one embodiment, the first scheduled session comprises a charging start time and a charging end time of the first grid. In one embodiment, the first scheduled session comprises a discharging start time and a discharging end time of the first grid.

In one embodiment, the method further comprises: determining, using the global positioning unit, a distance between a current location of the vehicle and a location of a second charging station associated with the second grid upon the vehicle entering the second geographical range. In one embodiment, the method further comprises: displaying an interactive menu onto a display of the vehicle depicting a monetization opportunity and an optimized route to the location of the second charging station upon determining the distance between the current location of the vehicle and the location of the charging station.

In one embodiment, the second charging station is a Vehicle-to-Everything (V2X), that comprises Vehicle-to-Grid (V2G), Vehicle-to-Home (V2H), and Vehicle-to-Load (V2L).

In one embodiment, the method further comprises: establishing the connection between the vehicle and the second grid based on user interactions with the user interactive menu.

In one embodiment, the method further comprises: transmitting the first charging information and the first discharging information to the second grid upon establishing the connection between the vehicle and the second grid.

In one embodiment, the first charging information comprises an identification number of a first charging station associated with the first grid, the first scheduled session, a first mode of charging, a location of the first charging station, an amount of energy transferred from the first charging station to the vehicle, a first charging cost, a first charging duration, a first charging sequence, and a first charging temperature.

In one embodiment, the first discharging information comprises at least one of a first mode of discharging, an amount of energy discharged from the vehicle to the first charging station, a first monetary value, a first discharging duration, a first discharging sequence, and a first discharging temperature.

In one embodiment, the first charging station is a Vehicle-to-Everything (V2X), that comprises Vehicle-to-Grid (V2G), Vehicle-to-Home (V2H), and Vehicle-to-Load (V2L).

In one embodiment, the method further comprises: communicating a second notification to the first grid upon establishing the connection between the vehicle and the second grid during the first scheduled session.

In one embodiment, the method further comprises: automatically identifying communication protocols and network parameters of the second grid upon detecting entry of the vehicle into the second geographical range. In one embodiment, the method further comprises: initiating a communication link between the vehicle and the second grid upon identifying the communication protocols and the network parameters.

In one embodiment, the method further comprises: transmitting vehicle state information to the second grid. In one embodiment, the method further comprises: transmitting the vehicle state information to the first grid. In one embodiment, the vehicle state information comprises at least one of location information of the vehicle, information of a travel path set in a navigation system, state-of-charge (SoC) of a battery pack, and information of battery power consumed per unit of time.

In one embodiment, the method further comprises: transmitting first billing information to the second grid. In one embodiment, the first billing information comprises an amount of energy discharged from the vehicle to the first grid, tariff rates applied by the first grid for energy discharge, first payment details, first cost breakdown, and first transaction timestamps corresponding to the first grid.

In one embodiment, the method further comprises: transmitting first energy source information to the second grid. In one embodiment, the first energy source information comprises identification of primary energy sources utilized by the vehicle at the first grid. In one embodiment, the primary energy sources comprise one or more renewable sources and one or more conventional sources.

In one embodiment, the method further comprises: training the Artificial intelligence engine based on the vehicle state information, the first billing information, the first energy source information, the user preferences, first load and demand data of the first grid, and vehicle routing and navigation data.

In one embodiment, the first load and demand data comprise real-time data on current load conditions of the first grid, historical data on one or more load levels of the first grid, and predictions about future demands of the first grid. In one embodiment, the vehicle routing and navigation data comprise real-time GPS data obtained from the global positioning unit, historical data on previous routes travelled by the vehicle and driving behaviors, and planned routes and intermediary stops for future journeys.

In one embodiment, the method further comprises: receiving second charging information and second discharging information from the second grid. In one embodiment, the second charging information comprises an identification number of the second charging station, a second scheduled session, a second mode of charging, the location of the second charging station, an amount of energy transferred from the second charging station to the vehicle, a second charging cost, a second charging duration, a second charging sequence, and a second charging temperature. In one embodiment, the second discharging information comprises at least one of a second mode of discharging, an amount of energy discharged from the vehicle to the second charging station, a second monetary value, a second discharging duration, a second discharging sequence, and a second discharging temperature.

In one embodiment, the method further comprises: receiving second billing information from the second grid. In one embodiment, the second billing information comprises an amount of energy discharged from the vehicle to the second grid, tariff rates applied by the second grid for energy discharge, second payment details, second cost breakdown, and second transaction timestamps corresponding to the second grid.

In one embodiment, the method further comprises: receiving second energy source information from the second grid. In one embodiment, the method further comprises: transmitting the second charging information, the second discharging information, the second billing information and the second energy source information to the first grid.

In one embodiment, the method further comprises: establishing a connection with the first grid and the second grid simultaneously. In one embodiment, the connection with the first grid and the second grid is established through a network. In one embodiment, the network comprises a communication network selected from a group comprising wired networks, wireless networks, and a combination thereof.

In one embodiment, the method further comprises: establishing the connection with the first grid and the second grid through a vehicle computer system.

In one embodiment, the method further comprises: training the Artificial intelligence engine based on the second charging information, the second discharging information, the second billing information, the second energy source information, and second load and demand data of the second grid.

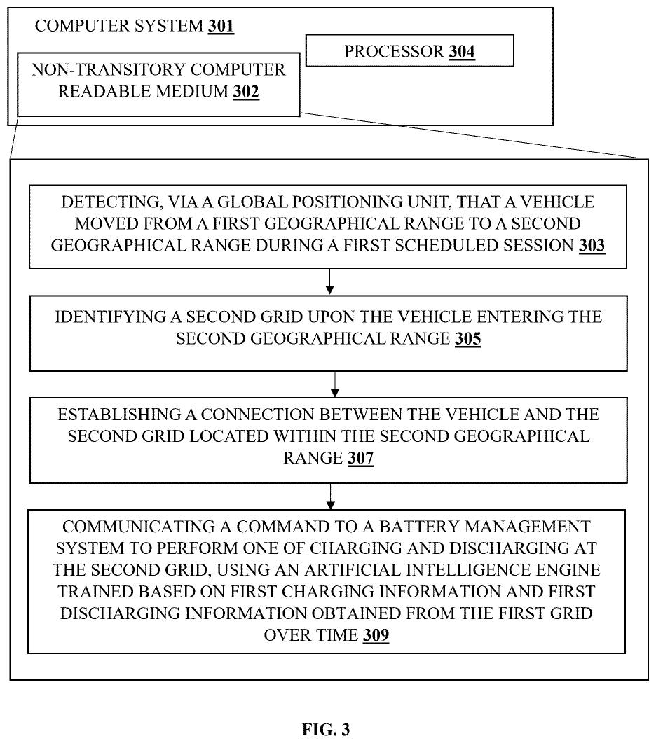

As an example, FIG. 3 illustrates a non-transitory computer readable storage medium 302, according to one or more embodiments. According to an embodiment, disclosed is a computer system 301 comprising the non-transitory computer-readable medium 302 having stored thereon instructions executable by a processor 304 to perform operations comprising: detecting, via a global positioning unit, that a vehicle moved from a first geographical range to a second geographical range during a first scheduled session corresponding to a first grid (at step 303); identifying a second grid upon the vehicle entering the second geographical range (at step 305); establishing a connection between the vehicle and the second grid located within the second geographical range (at step 307); and communicating a command to a battery management system to perform one of charging and discharging at the second grid, using an artificial intelligence engine trained, based on first charging information and first discharging information obtained from the first grid over time (at step 309).

In one embodiment, the non-transitory computer readable storage medium further causes: transmitting a first notification to the first grid upon detecting movement of the vehicle from the first geographical range to the second geographical range during the first scheduled session. In one embodiment, the first notification comprises identification information of the second geographical range and the first scheduled session.

In one embodiment, the first scheduled session comprises a charging start time and a charging end time of the first grid. In one embodiment, the first scheduled session comprises a discharging start time and a discharging end time of the first grid.

In one embodiment, the non-transitory computer readable storage medium further causes: determining, using the global positioning unit, a distance between a current location of the vehicle and a location of a second charging station associated with the second grid upon the vehicle entering the second geographical range. In one embodiment, the non-transitory computer readable storage medium further causes: displaying an interactive menu onto a display of the vehicle depicting a monetization opportunity and an optimized route to the location of the second charging station upon determining the distance between the current location of the vehicle and the location of the charging station.

In one embodiment, the second charging station is a Vehicle-to-Everything (V2X), that comprises Vehicle-to-Grid (V2G), Vehicle-to-Home (V2H), and Vehicle-to-Load (V2L).

In one embodiment, the non-transitory computer readable storage medium further causes: establishing the connection between the vehicle and the second grid based on user interactions with the user interactive menu.

In one embodiment, the non-transitory computer readable storage medium further causes: transmitting the first charging information and the first discharging information to the second grid upon establishing the connection between the vehicle and the second grid. In one embodiment, the first charging information comprises an identification number of a first charging station associated with the first grid, the first scheduled session, a first mode of charging, a location of the first charging station, an amount of energy transferred from the first charging station to the vehicle, a first charging cost, a first charging duration, a first charging sequence, and a first charging temperature. In one embodiment, the first discharging information comprises at least one of a first mode of discharging, an amount of energy discharged from the vehicle to the first charging station, a first monetary value, a first discharging duration, a first discharging sequence, and a first discharging temperature.

In one embodiment, the first charging station is a Vehicle-to-Everything (V2X), that comprises Vehicle-to-Grid (V2G), Vehicle-to-Home (V2H), and Vehicle-to-Load (V2L).

In one embodiment, the non-transitory computer readable storage medium further causes: communicating a second notification to the first grid upon establishing the connection between the vehicle and the second grid during the first scheduled session. In one embodiment, the non-transitory computer readable storage medium further causes: automatically identifying communication protocols and network parameters of the second grid upon detecting entry of the vehicle into the second geographical range. In one embodiment, the non-transitory computer readable storage medium further causes: initiating a communication link between the vehicle and the second grid upon identifying the communication protocols and the network parameters.

In one embodiment, the non-transitory computer readable storage medium further causes: transmitting vehicle state information to the second grid. In one embodiment, the non-transitory computer readable storage medium further causes: transmitting the vehicle state information to the first grid. In one embodiment, the vehicle state information comprises at least one of location information of the vehicle, information of a travel path set in a navigation system, state-of-charge (SoC) of a battery pack, and information of battery power consumed per unit of time.

In one embodiment, the non-transitory computer readable storage medium further causes: transmitting first billing information to the second grid. In one embodiment, the first billing information comprises an amount of energy discharged from the vehicle to the first grid, tariff rates applied by the first grid for energy discharge, first payment details, first cost breakdown, and first transaction timestamps corresponding to the first grid.

In one embodiment, the non-transitory computer readable storage medium further causes: transmitting first energy source information to the second grid. In one embodiment, the first energy source information comprises identification of primary energy sources utilized by the vehicle at the first grid. In one embodiment, the primary energy sources comprise one or more renewable sources and one or more conventional sources.

In one embodiment, the non-transitory computer readable storage medium further causes: training the Artificial intelligence engine based on the vehicle state information, the first billing information, the first energy source information, the user preferences, first load and demand data of the first grid, and vehicle routing and navigation data. In one embodiment, the first load and demand data comprise real-time data on current load conditions of the first grid, historical data on one or more load levels of the first grid, and predictions about future demands of the first grid.

In one embodiment, the vehicle routing and navigation data comprise real-time GPS data obtained from the global positioning unit, historical data on previous routes travelled by the vehicle and driving behaviors, and planned routes and intermediary stops for future journeys.

In one embodiment, the non-transitory computer readable storage medium further causes: receiving second charging information and second discharging information from the second grid.

In one embodiment, the second charging information comprises an identification number of the second charging station, a second scheduled session, a second mode of charging, the location of the second charging station, an amount of energy transferred from the second charging station to the vehicle, a second charging cost, a second charging duration, a second charging sequence, and a second charging temperature. In one embodiment, the second discharging information comprises at least one of a second mode of discharging, an amount of energy discharged from the vehicle to the second charging station, a second monetary value, a second discharging duration, a second discharging sequence, and a second discharging temperature.

In one embodiment, the non-transitory computer readable storage medium further causes: receiving second billing information from the second grid. In one embodiment, the second billing information comprises an amount of energy discharged from the vehicle to the second grid, tariff rates applied by the second grid for energy discharge, second payment details, second cost breakdown, and second transaction timestamps corresponding to the second grid.

In one embodiment, the non-transitory computer readable storage medium further causes: receiving second energy source information from the second grid. In one embodiment, the non-transitory computer readable storage medium further causes: transmitting the second charging information, the second discharging information, the second billing information and the second energy source information to the first grid. In one embodiment, the non-transitory computer readable storage medium further causes: establishing a connection with the first grid and the second grid simultaneously.

In one embodiment, the connection with the first grid and the second grid is established through a network. In one embodiment, the network comprises a communication network selected from a group comprising wired networks, wireless networks, and a combination thereof.

In one embodiment, the non-transitory computer readable storage medium further causes: establishing the connection with the first grid and the second grid through a vehicle computer system.

In one embodiment, the non-transitory computer readable storage medium further causes: training the Artificial intelligence engine based on the second charging information, the second discharging information, the second billing information, the second energy source information, and second load and demand data of the second grid.

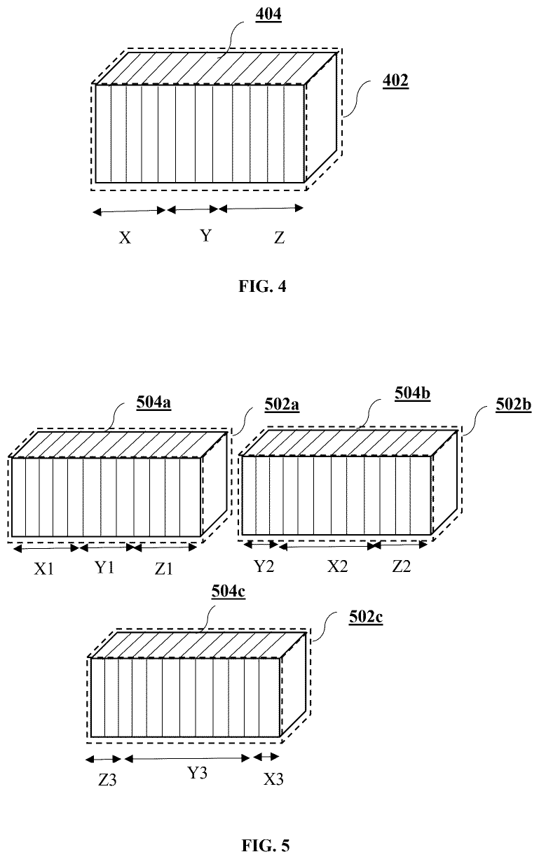

As an example, FIG. 4 illustrates a battery pack 402 comprising an individual battery, according to one or more embodiments. The battery pack 402 may be the battery within the charging station. In one embodiment, the battery pack 402 is within a vehicle. The battery pack 402 within the charging station is stationary and large enough to supply power to charge multiple vehicles simultaneously. The battery within the charging station is huge when compared to the battery within the electric vehicles. The battery pack 402 herein comprises an individual battery. The battery comprises a plurality of cells 404. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health. The second portion Y may comprise a second state-of-health. The third portion Z may comprise a third state-of-health. In an embodiment, the first portion may refer to a portion of the battery having degraded cells. The second portion may refer to a portion of the battery having healthy cells. The third portion may refer to a portion of the battery having moderate degraded cells. The processor may be configured to detect the state-of-charge of the battery pack 402 having at least one of healthy cells, degraded cells, and moderate degraded cells.

As an example, FIG. 5 illustrates a battery pack comprising a plurality of batteries, according to one or more embodiments. The battery pack herein comprises a first battery 502a, a second battery 502b, and a third battery 502c. The first battery 502a may comprise a plurality of first cells 504a. The second battery 502b may comprise a plurality of second cells 504b. The third battery 502c may comprise a plurality of third cells 504c. Each battery of the battery pack is connected electrically to get charged. The charging station charges each battery of the battery pack. The charging station may charge each battery of the battery pack through at least one of randomly, serially, and parallelly.

The charging station may charge at least one of a first portion X, a second portion Y, and a third portion Z of the battery pack. The first portion X of the battery pack refers to degraded cells from one or more batteries of the battery pack (X=X1+X2+X3). The second portion Y of the battery pack refers to healthy cells from one or more batteries of the battery pack (Y=Y1+Y2+Y3). The third portion Z of the battery pack refers to moderate degraded cells from one or more batteries of the battery pack (Z=Z1+Z2+Z3). Healthy cells may be contiguous or non-contiguously located within the same battery. Similarly, degraded, and moderate degraded cells may be contiguous or non-contiguously located within the same battery. In one embodiment, the charging station may charge in combination of degraded cells, healthy cells, and moderate degraded cells from the one or more batteries.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, computes the state-of-charge considering the state-of-health information.

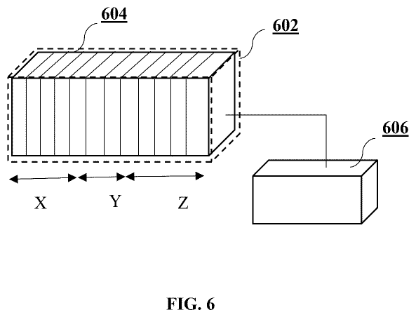

As an example, FIG. 6 schematically shows a battery pack comprising a battery 602 and a battery management system 606, according to one or more embodiments. The battery 602 in turn comprises a plurality of cells 604. The battery management system 606 may include a microprocessor, microcontroller, programmable digital signal processor, or another programmable device. The battery management system 606 may also or alternatively comprise an application specific integrated circuit, a programmable gate array or programmable array logic, a programmable logic device or a digital signal processor. Where the battery management system 606 comprises a programmable device such as the microprocessor, microcontroller or programmable digital signal processor mentioned above, the processor may also comprise computer executable code which controls the operation of the programmable device. In an embodiment, the battery management system 606 resides within an electric vehicle. The battery management system 606 determines the state-of-charge (SoC) of the battery pack and communicates to the charging station via a vehicle computer system.

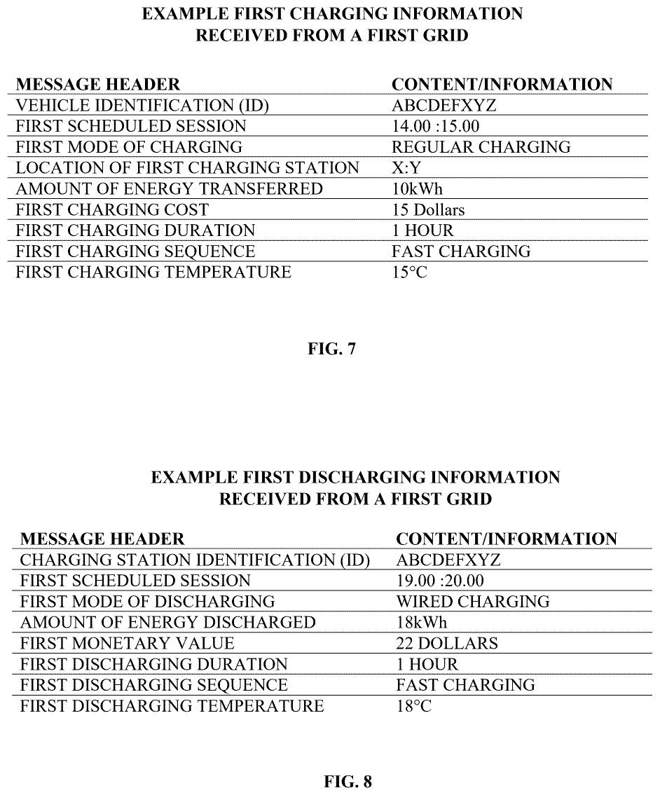

As an example, FIG. 7 illustrates first charging information received from a first grid, according to one or more embodiments. The first charging information comprises fields such as an identification number of a first charging station associated with the first grid, the first scheduled session, a first mode of charging, a location of the first charging station, an amount of energy transferred from the first charging station to the vehicle, a first charging cost, a first charging duration, a first charging sequence, and a first charging temperature. The first scheduled session refers to the designated time slot or period set in advance for charging the vehicle's battery at the charging station in the first grid. The first mode of charging refers to a method or protocol used to transfer electrical energy from the first grid to recharge the battery of an electric vehicle. The first charging cost refers to an initial expenditure involved in recharging the electric vehicle's battery from the first grid during its first charging session. The first charging duration refers to the total elapsed time taken for the electric vehicle to complete its initial charging session from the beginning of connecting to the first charging station until the EV is fully charged or reaches a desired state of charge. The first charging sequence refers to a charging pattern defined by the charging system, or the first charging station, based on the vehicle's battery parameters (e.g., state-of-charge, state-of-health) and charging time. The first charging temperature refers to the ambient or battery temperature conditions observed or controlled during the initial charging session of the electric vehicle with the first charging station. The first charging information may comprise the above fields with revised values that may be acceptable to the electric vehicle.

As an example, FIG. 8 illustrates first discharging information received from a first grid, according to one or more embodiments. The first discharging information comprises fields such as an identification number of a first charging station associated with the first grid, a first scheduled session for discharge, a first mode of discharging, an amount of energy discharged from the vehicle to the first charging station, a first monetary value, a first discharging duration, a first discharging sequence, and a first discharging temperature. The first charging station ID may be a serial identification number, or a tag associated with the first charging station configured to identify, recognize, and locate the first charging station. The first charging sequence indicates a charging pattern by which the first battery packs of the first charging station have to be charged using the power received from the electric vehicle. The first scheduled session indicates a range of start time to end time of the charging session during which the first charging station receives the power from the electric vehicles. The first charging duration refers to the total time for which the charging session is scheduled. The first monetary value may refer to the cost estimated by the processor for receiving power from the electric vehicle in accordance with the demand percentile score. The first discharging information may comprise the above fields with revised values that may be acceptable to the electric vehicle.

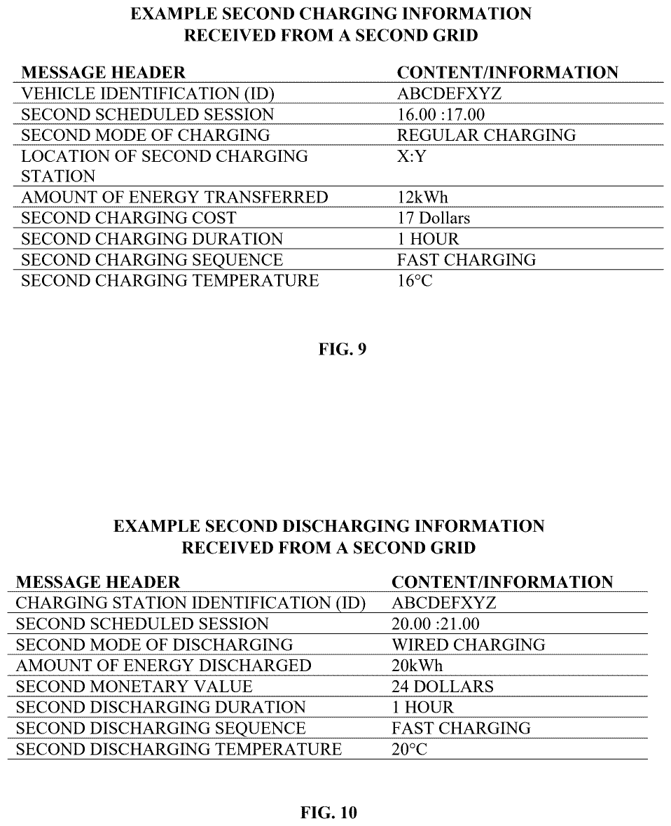

As an example, FIG. 9 illustrates second charging information received from a second grid, according to one or more embodiments. The second charging information is obtained from the second grid over time. The second charging information comprises fields such as an identification number of a second charging station associated with the second grid, the second scheduled session, a second mode of charging, a location of the second charging station, an amount of energy transferred from the second charging station to the vehicle, a second charging cost, a second charging duration, a second charging sequence, and a second charging temperature. The second scheduled session refers to the designated time slot or period set in advance for charging the vehicle's battery at the charging station in the second grid. The second mode of charging refers to a method or protocol used to transfer electrical energy from the second grid to recharge the battery of an electric vehicle. The first charging cost refers to an initial expenditure involved in recharging the electric vehicle's battery from the second grid during its second charging session. The second charging duration refers to the total elapsed time taken for the electric vehicle to complete its initial second charging session from the beginning of connecting to the second charging station until the electric vehicle is fully charged or reaches a desired state of charge. The second charging sequence refers to a charging pattern defined by the charging system, or the second charging station, based on the vehicle's battery parameters (e.g., state-of-charge, state-of-health) and charging time. The second charging temperature refers to the ambient or battery temperature conditions observed or controlled during the initial second charging session of the electric vehicle with the second charging station. The second charging information may comprise the above fields with revised values that may be acceptable to other electric vehicles.

As an example, FIG. 10 illustrates second discharging information, according to one or more embodiments. The second discharging information is obtained from the second grid over time. The second discharging information comprises fields such as an identification number of a second charging station associated with the second grid, a second scheduled session for discharge, a second mode of discharging, an amount of energy discharged from the vehicle to the second charging station, a second monetary value, a second discharging duration, a second discharging sequence, and a second discharging temperature. The second discharging information may comprise the above fields with revised values that may be acceptable to other electric vehicles.

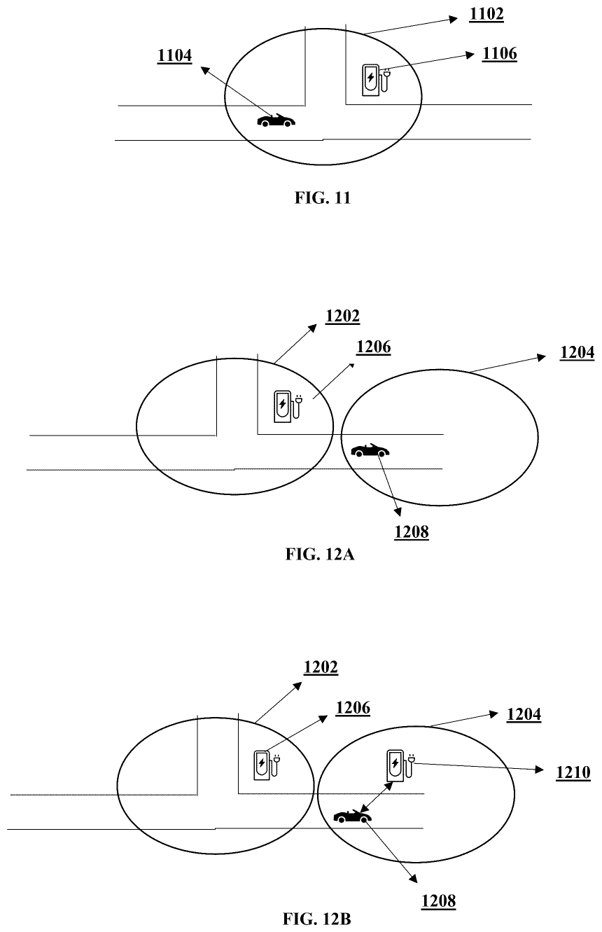

As an example, FIG. 11 illustrates a vehicle 1104 within a first geographical range 1102, according to one or more embodiments. The system comprises a global positioning unit. The system detects, via the global positioning unit, that a vehicle is in the first geographical range 1102 during a first scheduled session corresponding to a first grid. The system establishes a connection between the vehicle 1104 and a first charging station 1106 within the first grid located in the first geographical range 1102. The system receives first charging information from the first grid over time when the vehicle 1104 is connected for battery charging at the first grid. The system receives first discharging information from the first grid over time when the vehicle 1104 is connected for discharging the energy to the first grid. The system may receive the first billing information from the first grid. The first billing information may include an amount of energy discharged from the vehicle 1104 to the first grid, tariff rates applied by the first grid for energy discharge, first payment details, first cost breakdown, and first transaction timestamps corresponding to the first grid. The system may receive first energy source information from the first grid. The first energy source information may include identification of primary energy sources utilized by the vehicle 1104 at the first grid. The primary energy sources may include one or more renewable sources (e.g., solar power, wind power, etc.) and one or more conventional sources (e.g., coal, natural gas, oil, etc.)

As an example, FIG. 12A illustrates a vehicle 1208 moving from a first geographical range 1202 to a second geographical range 1204, according to one or more embodiments. The system comprises a global positioning unit. The system detects, via the global positioning unit, movement from the first geographical range 1202 to the second geographical range 1204 during a first scheduled session corresponding to a first charging station 1206 located in a first grid. The system identifies a second grid upon the vehicle 1208 entering the second geographical range 1204. The system is operable to transmit a first notification to the first grid upon detecting movement of the vehicle 1208 from the first geographical range 1202 to the second geographical range 1204 during the first scheduled session. The first notification comprises identification information of the second geographical range 1204 and the first scheduled session.

As an example, FIG. 12B illustrates establishment of a connection between the vehicle 1208 and the second grid, according to one or more embodiments. The system establishes the connection between the vehicle 1208 and a second charging station 1210 within the second grid located in the second geographical range 1204 upon identifying the second grid in the second geographical range 1204. The system communicates a command to a battery management system to perform one of charging and discharging at the second grid in the second geographical range 1204, using an artificial intelligence engine trained, based on first charging information and first discharging information obtained from the first grid over time.

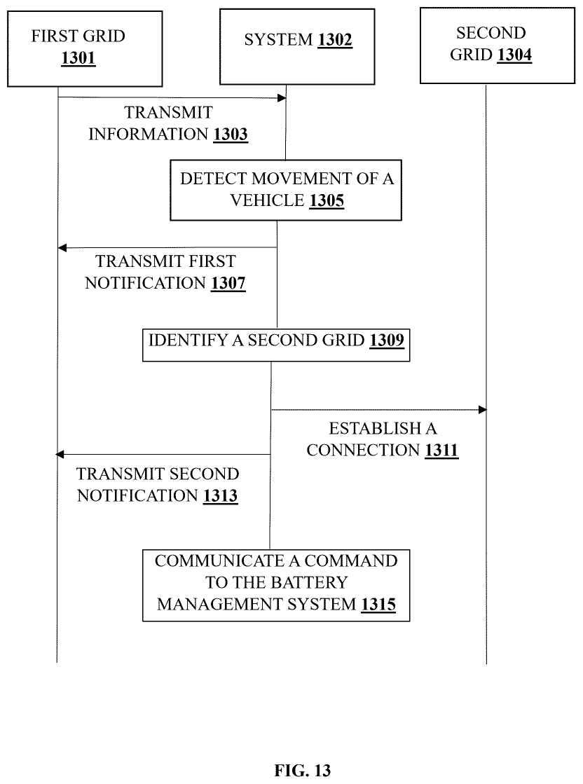

As an example, FIG. 13 illustrates a communication flow between a system 1302, a first grid 1301, and a second grid 1304, according to one or more embodiments. The system 1302 establishes a connection with the first grid 1301 and the second grid 1304. The connection enables data transfer and power transfer between the system 1302, the first grid 1301, and the second grid 1304. At step 1303, the first grid 1301 transmits information that comprises first charging information and first discharging information to the system 1302. In an embodiment, the first grid 1301 transmits the first billing information, the first energy source information, first load and demand data of the first grid 1301, and vehicle routing and navigation data to the system 1302. At step 1305, the system 1302 detects, via a global positioning unit, that a vehicle moved from a first geographical range to a second geographical range during a first scheduled session corresponding to the first grid 1301. At step 1307, the system 1302 transmits a first notification to the first grid 1301 upon detecting movement of the vehicle from the first geographical range to the second geographical range during the first scheduled session. The first notification may include identification information of the second geographical range and the first scheduled session. At step 1309, the system 1302 identifies a second grid 1304 upon the vehicle entering the second geographical range. At step 1311, the system 1302 establishes a connection between the vehicle and the second grid 1304 located within the second geographical range. At step 1313, the system 1302 transmits a second notification to the first grid 1301 upon establishing the connection between the vehicle and the second grid 1304 during the first scheduled session. In an embodiment, the system 1302 enables the first grid 1301 to recalibrate the first scheduled session based on the second notification. At step 1315, the system 1302 communicates a command to a battery management system 1302 to perform one of charging and discharging at the second grid 1304, using an artificial intelligence engine trained, based on first charging information and first discharging information obtained from the first grid 1301 over time. In one embodiment, the second grid 1304 recalibrates its distribution or acceptance parameters upon receiving the vehicle state information, the first billing information, the first energy source information, the user preference, the first load and demand data of the first grid 1301, and the vehicle routing and navigation data.

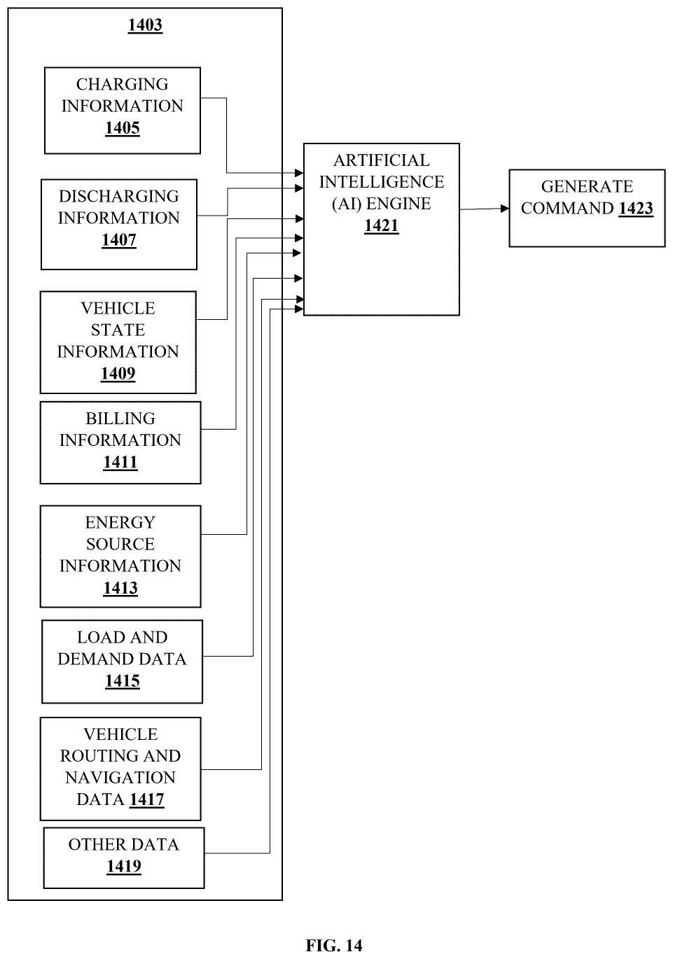

As an example, FIG. 14 shows an example block diagram for an artificial intelligence (AI) engine 1421 used in generating a command to perform one of charging and discharging according to one or more embodiments. The AI engine 1421 receives data from a first grid, a vehicle, and a second grid. The AI engine is trained using a dataset 1403 that comprises charging information 1405, discharging information 1407, vehicle state information 1409, billing information 1411, energy source information 1413, load and demand data 1415, and vehicle routing and navigation data 1417. In an embodiment, the charging information 1405 comprises first charging information received from the first grid and second charging information received from the second grid. In an embodiment, the discharging information 1407 comprises first discharging information received from the first grid and second discharging information received from the second grid. In an embodiment the billing information 1411 comprises first billing information received from the first grid and second billing information received from the second grid. In an embodiment, the energy source information 1413 comprises first energy source information received from the first grid and second energy source information received from the second grid. In an embodiment, the load and demand data 1415 comprises first load and demand data received from the first grid and second load and demand data received from the second grid.

The charging information 1405 includes an identification number of a first charging station associated with the first grid and the second grid, the scheduled charging session, the mode of charging, the location of the charging station, the amount of energy transferred to the vehicle, the charging cost, the duration of the charging session, the sequence of charging events, and the temperature during charging. The discharging information 1407 comprises the mode of discharging, the amount of energy discharged from the vehicle to the charging station, the monetary value of the discharged energy, the duration of the discharging session, the sequence of discharging events, and the temperature during discharging. The AI engine 1421 is trained using the vehicle state information 1409, which includes monitoring battery levels, health status, and current operational conditions. The vehicle state information 1409 enables the AI engine 1421 to determine the optimal times and amounts for charging the vehicle, ensuring it remains operational and efficient.

Further, the AI engine 1421 incorporates the billing information 1411, which includes the pricing information or tariffs set by the first grid and the second grid (e.g., home or office). The billing information 1411 enables the AI engine 1421 to schedule charging sessions during off-peak hours when electricity rates are lower, thereby optimizing cost savings for the vehicle owner. Further, the AI engine 1421 is trained with the energy source information 1413. The energy source information 1413 may comprise identification of primary energy sources utilized by the vehicle at the first grid and the second grid. The primary energy sources comprise one or more renewable sources and one or more conventional sources.

The AI engine 1421 integrates the load and demand data 1415 from the first grid and the second grid into its training. The AI engine 1421 is trained with user preferences, which can be received through various input methods such as in-car touchscreens, mobile apps, voice commands, or even through automated learning based on user behaviour and historical data. These preferences include personalized settings for charging schedules, maximum charge levels, and preferred energy sources. Additionally, the vehicle routing and navigation data 1417, which provide information on planned routes, destinations, and travel schedules, are integrated into the AI engine's training.

In addition to the data received from the first grid, the second grid, and the vehicle, the AI engine 1421 may be trained with other data 1419 such as real-time grid conditions that comprises factors such as current voltage levels, available capacity, and any operational constraints or maintenance schedules affecting grid stability and availability of electricity. Further, the AI engine 1421 may be trained with weather and environmental data to provide insights into conditions that impact energy consumption and the availability of renewable sources, guiding decisions on when to charge based on solar or wind availability. Further, the AI engine 1421 may be trained with traffic and driving patterns data that enable prediction of energy consumption rates and anticipate charging needs based on anticipated travel distances and traffic conditions. The AI engine may be trained with information on charging infrastructure availability along planned routes, including types of stations and their capabilities (such as fast charging), ensuring efficient route planning and reliable access to charging facilities. By continuously learning and adapting based on these varied inputs, the AI engine 1421 generates and communicates a command 1423 to the battery management system to perform one of charging and discharging at a new grid (e.g., the second grid) when the vehicle moves from a first geographical range to a second geographical range during a first scheduled session corresponding to the first grid.

In an embodiment of the system, the Artificial intelligence (AI) engine includes the machine learning model. In an embodiment, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

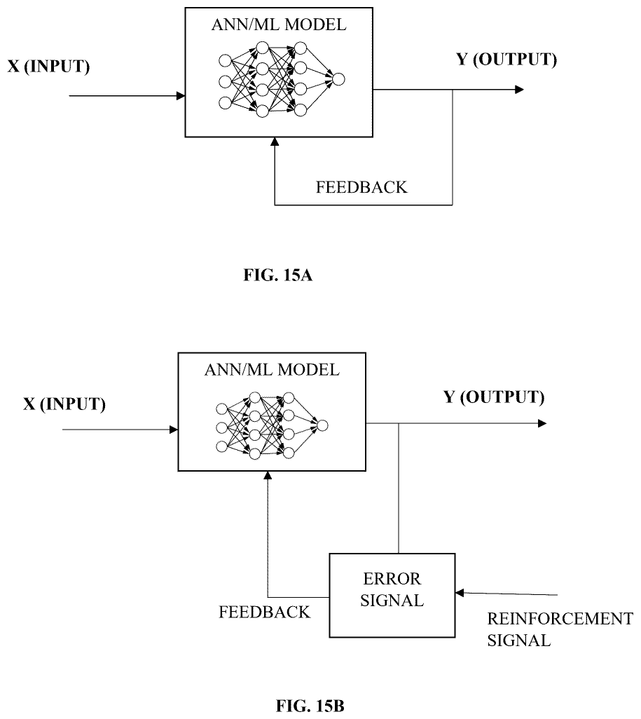

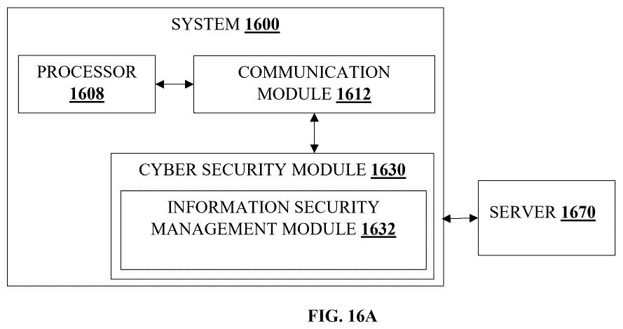

As an example, FIG. 15A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may communicate a command to the battery management system to perform one of charging and discharging at the second grid.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labelled data and concepts, after a while, the models'performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., identify a new grid, establish a connection, etc.) are used that are meant for the model to learn. Afterward, the model is tested using unlabelled data. By using, for example, deep learning and neural networks, the model can then make predictions on whether the desired concept/s (for e.g., identify a new grid, establish a connection, etc.) are in unlabelled images. Each image is given a probability score where higher scores represent a higher level of confidence in the models'predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

As an example, FIG. 15B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priority of the messages are evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging station and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

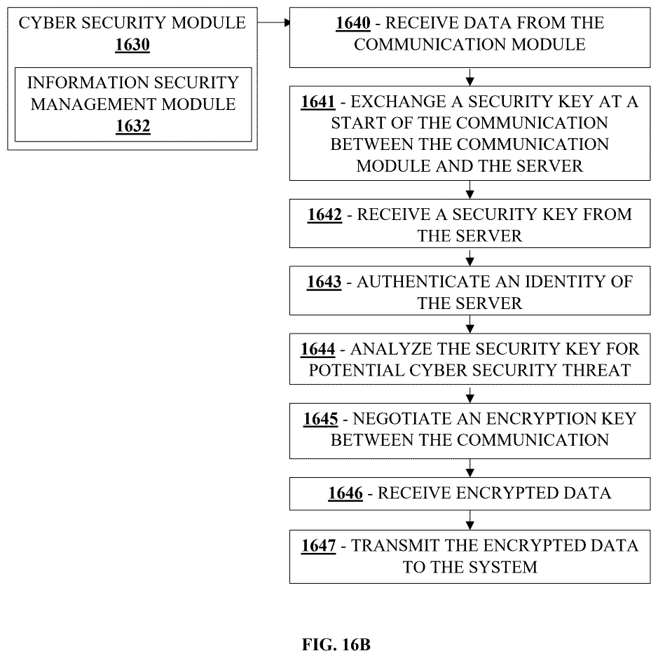

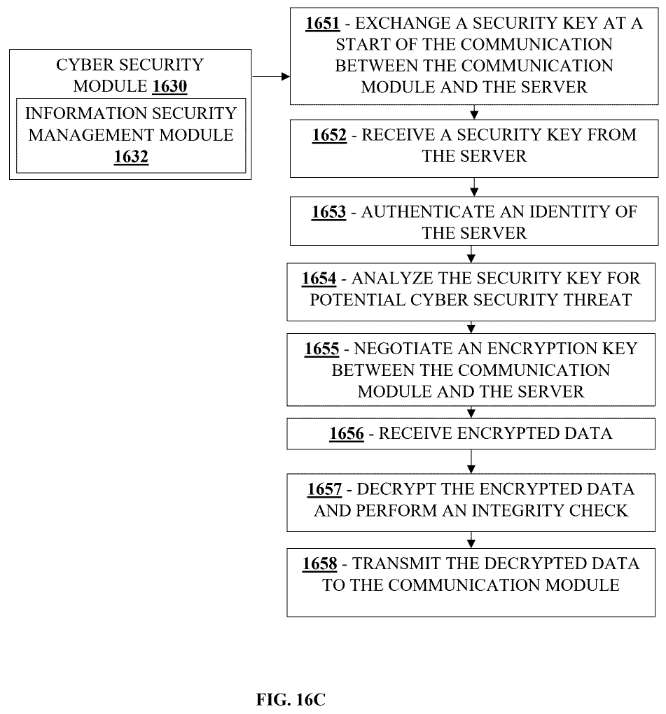

In an embodiment, FIG. 16A shows the block diagram of the cyber security module. The communication of data between the system 1600 and the server 1670, through the processor 1608, through the communication module 1612, is first verified by the information security management module 1632 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 16B shows the flowchart of securing the data through the cyber security module 1630. At step 1640, the information security management module 1632 is operable to receive data from the communication module. At step 1641, the information security management module exchanges a security key at a start of the communication between the communication module and the server. At step 1642, the information security management module receives a security key from the server. At step 1643, the information security management module authenticates an identity of the server by verifying the security key. At step 1644, the information security management module analyzes the security key for potential cyber security threats. At step 1645, the information security management module negotiates an encryption key between the communication module and the server. At step 1646, the information security management module receives the encrypted data. At step 1647, the information security management module transmits the encrypted data to the server when no cyber security threat is detected.

In an embodiment, FIG. 16C shows the flowchart of securing the data through the cyber security module 1630. At step 1651, the information security management module 1632 is operable to: exchange a security key at a start of the communication between the communication module and the server. At step 1652, the information security management module receives a security key from the server. At step 1653, the information security management module authenticates an identity of the server by verifying the security key. At step 1654, the information security management module analyzes the security key for potential cyber security threats. At step 1655, the information security management module negotiates an encryption key between the communication module and the server. At step 1656, the information security management module receives encrypted data. At step 1657, the information security management module decrypts the encrypted data, and performs an integrity check of the decrypted data. At step 1658, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 16A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-120. (canceled)

121. A system comprising:
a global positioning unit;
a battery management system; and
a processor storing instructions in non-transitory memory that, when executed, causes the processor to:
detect, via the global positioning unit, that a vehicle moved from a first geographical range to a second geographical range during a first scheduled session corresponding to a first grid;
identify a second grid upon the vehicle entering the second geographical range;
establish a connection between the vehicle and the second grid located within the second geographical range; and
communicate a command to the battery management system to perform one of charging and discharging at the second grid, using an artificial intelligence engine trained based on first charging information and first discharging information obtained from the first grid over time.

122. The system of claim 121, wherein the processor is operable to transmit a first notification to the first grid upon detecting movement of the vehicle from the first geographical range to the second geographical range during the first scheduled session.

123. The system of claim 122, wherein the first notification comprises identification information of the second geographical range and the first scheduled session.

124. The system of claim 121, wherein the first scheduled session comprises a charging start time, a charging end time, a discharging start time and a discharging end time of the first grid.

125. The system of claim 121, wherein the first charging information comprises an identification number of a first charging station associated with the first grid, the first scheduled session, a first mode of charging, a location of the first charging station, an amount of energy transferred from the first charging station to the vehicle, a first charging cost, a first charging duration, a first charging sequence, and a first charging temperature.

126. The system of claim 121, wherein the first discharging information comprises at least one of a first mode of discharging, an amount of energy discharged from the vehicle to the first charging station, a first monetary value, a first discharging duration, a first discharging sequence, and a first discharging temperature.

127. The system of claim 125, wherein the first charging station is a Vehicle-to-Everything (V2X) that comprise Vehicle-to-Grid (V2G), Vehicle-to-Home (V2H), and Vehicle-to-Load (V2L).

128. The system of claim 121, wherein the processor is operable to
receive first billing information that comprises an amount of energy discharged from the vehicle to the first grid, tariff rates applied by the first grid for energy discharge, first payment details, first cost breakdown, and first transaction timestamps from the first grid; and
receive first energy source information that comprises identification of primary energy sources utilized by the vehicle at the first grid.

129. The system of claim 121, wherein the processor is operable to transmit the first charging information, the first discharging information, the first billing information, the first energy source information and first load and demand data to the second grid upon establishing the connection between the vehicle and the second grid.

130. The system of claim 121, wherein the processor is operable to train the Artificial intelligence engine based on the first charging information, the first discharging information, vehicle state information, the first billing information, the first energy source information, user preference, the first load and demand data of the first grid, and vehicle routing and navigation data.

131. The system of claim 130, wherein the first load and demand data comprise real-time data on current load conditions of the first grid, historical data on one or more load levels of the first grid, and predictions about future demands of the first grid.

132. The system of claim 130, wherein the vehicle routing and navigation data comprise real-time GPS data obtained from the global positioning unit, historical data on previous routes travelled by the vehicle and driving behaviours, and planned routes and intermediary stops for future journeys.

133. The system of claim 121, wherein the processor is operable to communicate a second notification to the first grid upon establishing the connection between the vehicle and the second grid during the first scheduled session.

134. A method comprising:
detecting, via a global positioning unit, that a vehicle moved from a first geographical range to a second geographical range during a first scheduled session corresponding to a first grid;
identifying a second grid upon the vehicle entering the second geographical range;
establishing a connection between the vehicle and the second grid located within the second geographical range; and
communicating a command to a battery management system to perform one of charging and discharging at the second grid, using an artificial intelligence engine trained based on first charging information and first discharging information obtained from the first grid over time.

135. The method of claim 134, further comprising: determining, using the global positioning unit, a distance between a current location of the vehicle and a location of a second charging station associated with the second grid upon the vehicle entering the second geographical range.

136. The method of claim 135, further comprising: displaying an interactive menu onto a display of the vehicle depicting a monetization opportunity and an optimized route to the location of the second charging station upon determining the distance between the current location of the vehicle and the location of the second charging station.

137. The method of claim 136, further comprising: establishing the connection between the vehicle and the second grid based on user interactions with the interactive menu.

138. A non-transitory computer readable storage medium comprising a sequence of instructions, which when executed by a processor causes:
detecting, via a global positioning unit, that a vehicle moved from a first geographical range to a second geographical range during a first scheduled session corresponding to a first grid;
identifying a second grid upon the vehicle entering the second geographical range;
establishing a connection between the vehicle and the second grid located within the second geographical range; and
communicating a command to a battery management system to perform one of charging and discharging at the second grid, using an artificial intelligence engine trained based on first charging information and first discharging information obtained from the first grid over time.

139. The non-transitory computer readable storage medium of claim 138, further comprising: automatically identifying communication protocols and network parameters of the second grid upon detecting entry of the vehicle into the second geographical range.

140. The non-transitory computer readable storage medium of claim 139, further comprising: initiating a communication link between the vehicle and the second grid upon identifying the communication protocols and the network parameters in the second geographical range.
